(19) United States
(12) Patent Application Publication
(10) Pub. No.: US 2024/0399912 A1
(43) Pub. Date: Dec. 5, 2024

(54) Charger

(71) Applicant: EGTRONICS Co., Ltd., Hwaseong-Si (KR)

(72) Inventors: Chan-Ho Kang, Hwaseong-Si (KR); Young-Gun Hong, Goyang-Si (KR); Ui-Soung Park, Daejeon (KR); Ko Choi, Seoul (KR); Su-Kang Lee, Incheon (KR)

(21) Appl. No.: 18/679,944

(22) Filed: May 31, 2024

(30) Foreign Application Priority Data
Jun. 1, 2023 (KR) 10-2023-0070842

(51) Int. Cl. B60L 53/60; G01K 3/00; H02J 7/00

(52) U.S. Cl. CPC B60L 53/60; G01K 3/005; H02J 7/007192

(57) ABSTRACT

The present disclosure relates to a charger preventing interruption of charging of an electric vehicle even when an internal temperature of the charger rises, and includes a sensing unit configured to sense an internal temperature of the charger, and a controller provided at the charger, configured to control an output of the charger while charging an electric vehicle, and to perform a first monitoring mode in which the output is controlled to be reduced when the internal temperature of the charger sensed at the sensing unit exceeds a reference temperature.

### CROSS-REFERENCE TO RELATED APPLICATION(S)

This application is based on and claims priority of Korean Patent Application No. 10-2023-0070842, filed on Jun. 1, 2023 with the Korean Intellectual Property Office, the entire contents of which are hereby incorporated by reference.

### TECHNICAL FIELD

The present disclosure relates to a charger, and more specifically to a charger configured to prevent an interruption of charging or a fire caused by an increase of an internal temperature of the charger.

### BACKGROUND

In recent years, electric vehicles have gained popularity for environmental reasons. In the early 2010s, technology of electric vehicles was in its early stage, and the performance and travel distance of electric vehicles were not sufficient. However, advances in battery and motor technology have led to improvements in the performance and driving range of electric vehicles over time.

As electric vehicles become more prevalent, charging infrastructure is also becoming more widespread. Charging of electric vehicles can be broadly divided into fast charging and slow charging. In Korea, the slow charging system is mainly installed in shared housings and is used to charge electric vehicles over a long period of time.

While charging the electric vehicle with a charger, an internal temperature of the charger may increase. If the internal temperature of the charger increases, problems such as shortening of the lifetime of the charger, or a fire may occur, so in the case of a typical charger, charging of the electric vehicle is set to be interfered when the internal temperature of the charger is above a reference value. However, such interruption of charging the electric vehicle may cause dissatisfaction of users.

### SUMMARY

The present disclosure was devised to solve the problems described above, and the purpose of a charger according to an embodiment of the present disclosure is to prevent an interruption of charging even if an internal temperature of the charger increases, and prevent shortening of life time of the charger and shortening of life time and accidents such as a fire of an electric vehicle.

According to an embodiment of the present disclosure, a charger for charging an electric vehicle may be provided, including a sensing unit configured to sense an internal temperature of the charger; and a controller provided at the charger, configured to control an output of the charger while charging an electric vehicle, and to perform a first monitoring mode in which the output is controlled to be reduced when the internal temperature of the charger sensed at the sensing unit exceeds a reference temperature; wherein the controller is configured to perform a second monitoring mode in which the output is controlled to be further reduced when the internal temperature of the charger exceeds the reference temperature after a predetermined time has elapsed from reducing the output, and wherein the output reduced in the first monitoring mode is identical to or smaller than the output reduced in the second monitoring mode.

Further, the charger may be provided, wherein the controller is configured to repeatedly perform the second monitoring mode.

Further, the charger may be provided, wherein the output has a predetermined lower limit.

Further, the charger may be provided, wherein the controller is configured to control to increase the output if the internal temperature of the charger is equal to or less than the reference temperature after the first monitoring mode has been performed.

Further, the charger may be provided, wherein the controller is configured to control to increase the output if the internal temperature of the charger is equal to or less than the reference temperature after the second monitoring mode has been performed.

Further, the charger may be provided, wherein the sensing unit includes a temperature sensor with a Schmitt trigger method applied.

Further, the charger may be provided, wherein the controller is configured to control to increase the output after a preset time has elapsed from the time point at which the internal temperature of the charger is reduced to the reference temperature or below, if the internal temperature of the charger is reduced to the reference temperature or below after performing the first monitoring mode.

Further, the charger may be provided, wherein the controller is configured to control to increase the output after a preset time has elapsed from the time point at which the internal temperature of the charger is reduced to the reference temperature or below, if the internal temperature of the charger is reduced to the reference temperature or below after performing the second monitoring mode.

The charger according to the various embodiments of the present disclosure can reduce an internal temperature of the charger without interruption of charging even when the internal temperature of the charger is increased.

### BRIEF DESCRIPTION OF DRAWINGS

FIG. 1 is a schematic diagram of a charger according to a first example of the present disclosure.

FIG. 2 is a flowchart illustrating a method of controlling the charger according to the first example of the present disclosure.

FIGS. 3A and 3B illustrate an internal temperature and an output of the charger when a first monitoring mode and a second monitoring mode are performed by the charger according to the first example of the present disclosure.

FIG. 4 illustrates an internal temperature and an output of a charger when the first monitoring mode and the second monitoring mode are performed by a charger according to a second example of the present disclosure.

FIG. 5 illustrates an internal temperature and an output of a charger when the first monitoring mode and the second monitoring mode are performed by a charger according to a third example of the present disclosure.

FIG. 6 illustrates an internal temperature and an output of a charger when the first monitoring mode and the second monitoring mode are performed by a charger according to a fourth example of the present disclosure.

### DETAILED DESCRIPTION

The object, features, and advantages of the present disclosure will become more apparent with the following embodiments related to the attached drawings. The following specific structural or functional descriptions are exemplified for the purpose of illustrating embodiments in accordance with the concepts of the present disclosure only, and embodiments in accordance with the concepts of the present disclosure may be implemented in various forms and should not be construed as limiting to the embodiments described herein or in the application. Since the embodiments according to the concepts of the present disclosure are subject to various modifications and may take many forms, certain embodiments are to be illustrated in the drawings and described in detail in the present specification or application. However, this is not intended to limit the embodiments according to the concepts of the present disclosure to any particular disclosed form, and is to be understood to include all modifications, equivalents, or substitutions that fall within the scope of the ideas and techniques of the present disclosure. Terms such as first and/or second may be used to describe various components, but the components are not limited to the terms. The above terms are used solely for the purpose of distinguishing one component from another, e.g. a first component may be named a second component, and similarly a second component may be named a first component, without departing from the scope of the rights in accordance with the concept of the disclosure. When a component is referred to as coupled to or connected to another component, it should be understood that it may be directly coupled to or connected to that other component, but there may be other components in between. On the other hand, when a component is said to be directly coupled to or connected to another component, it should be understood that there is no other component in between. Other expressions to describe the relationship between components, such as between ˜ and directly between ˜ or adjacent to ˜ and directly adjacent to ˜, should be interpreted similarly. The terms used herein is intended to describe particular embodiments only and is not intended to limit the present disclosure. Singular expressions include plural expressions unless context clearly indicates otherwise. Terms used in the present disclosure such as include or comprise are intended to designate the presence of the features, numbers, steps, operations, components, parts, or combinations thereof described, and are not intended to preclude the presence or addition of one or more other features, numbers, steps, operations, components, parts, or combinations thereof. Unless otherwise defined, all terms used herein, including technical or scientific terms, have the same meaning as commonly understood by a person of ordinary skill in the technical field to which the present disclosure belongs. Terms such as those defined in commonly used dictionaries shall be construed to have meanings consistent with their meaning in the context of the relevant art and shall not be construed to have an idealized or unduly formal meaning unless expressly defined in this specification. Hereinafter, the present disclosure will be described in detail by describing the preferred embodiments of the present disclosure with reference to the attached drawings. The same reference numerals shown in each drawing refer to the same elements.

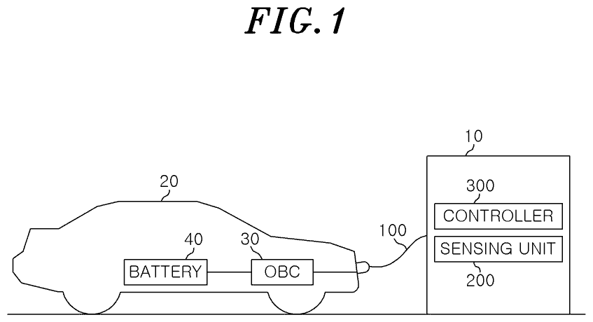

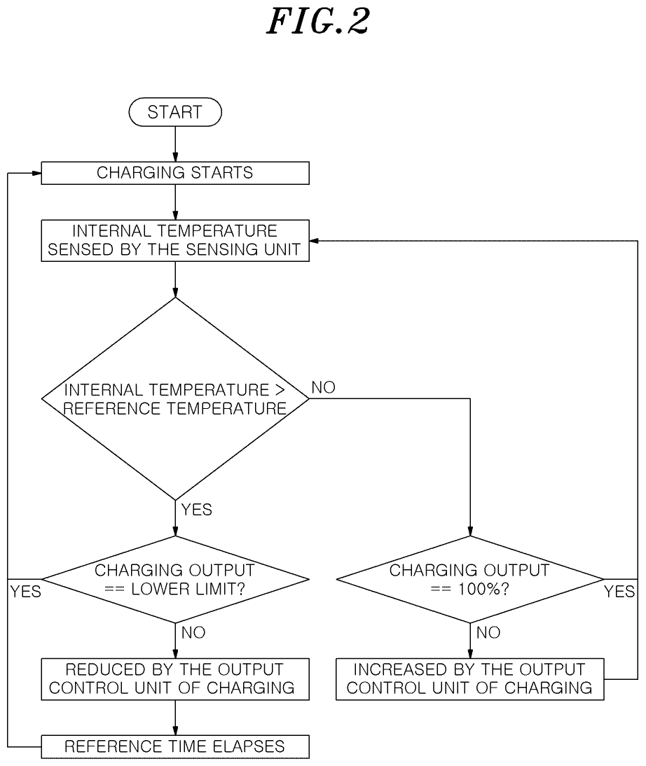

FIG. 1 is a schematic diagram of a charger according to a first example of the present disclosure, and FIG. 2 is a flowchart illustrating a method of controlling the charger according to the first example of the present disclosure.

As shown in FIG. 1, the charger according to the first example of the present disclosure is the charger 10 configured to charge an electric vehicle 20, and may include a sensing unit 200 and a controller 300.

First, the charger is connected to the electric vehicle 20 via a control pilot (CP) line 100 and supplies charging power. The charger 10 delivers the charging power to the electric vehicle 20 via the CP line 100, and an on board charger (OBC) 30 integrated to the electric vehicle 20 uses the received power to charge a battery 40.

The sensing unit 200 senses an internal temperature of the charger 10 and outputs the sensed value to the controller 300 which will be described later. To this end, the sensing unit 200 may include various types of temperature sensors, and the sensing unit 200 and the controller 300 may be connected by wire or wirelessly to transmit the sensing value. At least one of a thermocouple-type sensor, a sensor using a resistance temperature detector (RTD), a sensor using a thermistor, an infrared thermometer, and a bimetal thermometer may be used as the temperature sensor. Among the types of the temperature sensors, the infrared thermometer measures a temperature of an object using infrared rays, so it can be located on the outside of the charger 10 rather than the inside of the charger 10. For temperature sensors other than the infrared thermometer, they can be located on the inside of the charger 10. The internal temperature information of the charger 10 sensed by the sensing unit 200 is transmitted to the controller 300 in real time.

The temperature sensor may be a temperature sensor with a Schmitt trigger method applied. The Schmitt trigger is a functional logic gate used in electronic circuits. The Schmitt trigger has strong stability against noise or fluctuations of an input signal and operates using a discrete input signal. The temperature sensor with the Schmitt trigger applied has a characteristic that when the input signal exceeds a threshold, an output switches to a specific state, and regardless of the previous input signal, the output reacts directly to the magnitude of the input signal, and can operate stably even in the presence of noise or fluctuation.

The temperature sensor with the Schmitt trigger method applied may include a general RTD, a thermistor or infrared temperature sensor, a Schmitt trigger circuit, and a voltage/current control circuit. The Schmitt trigger circuit converts an analog signal output from the temperature sensor into a digital signal. The Schmitt trigger circuit sets a constant threshold and switches an output state for an input signal that exceeds this threshold. Here, the threshold may be a value corresponding to the reference temperature described earlier. The voltage/current control circuit modulates the output signal of the temperature sensor and outputs it to the Schmitt trigger circuit. The voltage/current control circuit is not an essential component, but it is used to adjust the signal according to the characteristics of the temperature sensor and optimize the operating range of the Schmitt trigger circuit. The output of the Schmitt trigger circuit is in a digital form, and the output signal is input to the controller 300.

The Schmitt trigger allows the output of an analog circuit to have a discrete value and can improve the circuit's stability and resistance to noise. Due to such characteristics, it is widely used in various application fields such as digital circuits, signal shaping, and readout circuits.

The controller 300 controls the operation of the charger according to the first example of the present disclosure, as shown in FIG. 2.

First, when the sensing unit 200 senses the internal temperature of the charger 10, the controller 300 receives the internal temperature of the charger 10 from the sensing unit 200. The controller 300 is provided inside the charger 10, and if the internal temperature is higher than the reference temperature, it controls the output during charging of the electric vehicle 20. More specifically, the controller 300 controls the charger 10 to reduce the output when the internal temperature of the sensing unit 200 exceeds the reference temperature. The controller 300 may be implemented as an electronic device or an apparatus including an electronic device to perform the operation described above. The above operation is called a first monitoring mode.

The present disclosure can induce the internal temperature of the charger 10 to be lowered through the first monitoring mode, thereby preventing problems such as damage to the charger 10, the electric vehicle 20, and the charging infrastructure without interrupting the charging of the electric vehicle 20 due to a high temperature phenomenon of the charger 10.

The controller 300 reduces the output according to the internal temperature of the charger 10 and monitors the internal temperature of the charger 10 while a predetermined time elapses. After the predetermined time has elapsed, if the internal temperature of the charger 10 is still higher than the reference temperature, the controller 300 controls the charger 10 to further reduce the output. This operation is called a second monitoring mode.

The controller 300 determines whether the internal temperature of the charger 10 is still higher than the reference value after a predetermined time has elapsed from the time point of reducing the output. If the internal temperature is still higher than the reference value, the second monitoring mode is performed to additionally reduce the output flowing toward the electric vehicle 20. The second monitoring mode may be repeatedly performed, but the output of the charger 10 may have a lower limit set, and the controller 300 does not reduce the output below the lower limit of the charger 10. That is, the magnitude of the current reduced by the second monitoring mode may have a lower limit.

When the second monitoring mode is repeatedly performed, the output of the charger 10 to the electric vehicle 20 is set to the lower limit, and if the condition for the second monitoring mode to be performed is satisfied even after the lower limit is set, a message including status information of the charger 10 may be transmitted to a pre-stored contact to notify the abnormality of the charger 10. Here, the pre-stored contact may be at least one of an operating entity of the charger according to the present disclosure and an owner of the electric vehicle 20.

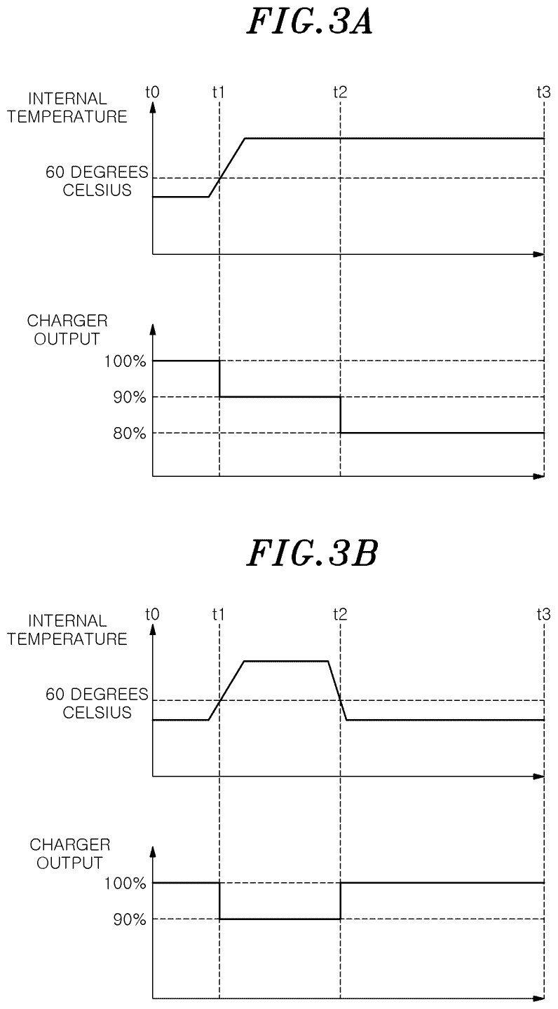

FIGS. 3A and 3B illustrate an internal temperature and an output of the charger when the first monitoring mode and the second monitoring mode are performed by the charger according to the first example of the present disclosure.

As shown in FIG. 3A, the internal temperature of the charger 10 in a normal state (interval between t0 and t1) may be equal to or less than 60 degrees Celsius. The controller 300 supplies 100% of the output of the charger 10 to the electric vehicle 20 when the internal temperature of the charger 10 is equal to or less than 60 degrees Celsius. Thereafter, as in an interval between the t1 and t2, if the internal temperature of the charger 10 rises above the reference temperature of 60 degrees Celsius, the controller 300 sets the output of the charger 10 to 90%, which is reduced by 10% from 100%. The controller 300 determines whether the internal temperature of the charger 10 still exceeds the reference temperature when a predetermined time (e.g., 30 minutes) has elapsed from the time point of controlling to reduce the output of the charger 10 by 10%. As in the interval between t2 and t3 of FIG. 3A, if the internal temperature of the charger 10 is still higher than the reference temperature of 60 degrees Celsius, the controller 300 performs the second monitoring mode, which reduces the output of charger 10 by an additional 10%. As shown in FIG. 3A, the output of the charger 10 is 80% after the second monitoring mode is performed, the second monitoring mode may be repeatedly performed, but the output of the charger 10 may have a lower limit set such as 70%, and the controller 300 does not reduce the output of the charger 10 any further.

On the other hand, in FIG. 3B, an interval between t0 and t1 and an interval between t1 and t2 are the same as in FIG. 3A, but an interval between t2 and t3 is different. More specifically, as shown in FIG. 3B, if the internal temperature of the charger 10 becomes 60 degrees Celsius or less in the interval between t2 and t3, the controller 300 may control the charger 10 to increase the output from 90% to 100%.

When describing the first monitoring mode and the second monitoring mode with reference to FIGS. 3A and 3B, the magnitude of the output that decreases and increases is explained in units of 10%. However, the present disclosure does not limit the output control unit of the charger 10 to 10%, and the output control unit of the charger 10 can be varied according to necessity, and decreasing/increasing output control units may be identical to or different from each other.

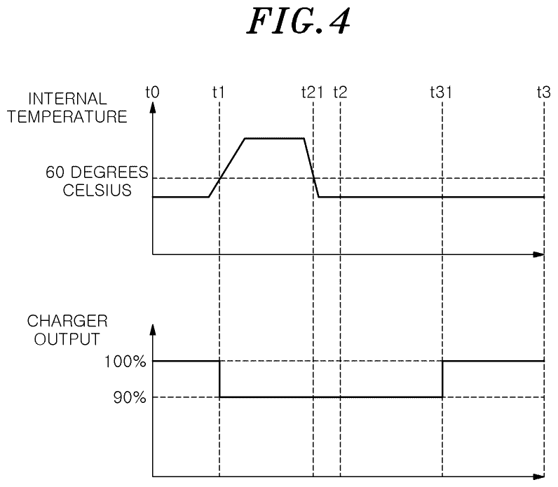

FIG. 4 illustrates an internal temperature and an output of a charger when the first monitoring mode and the second monitoring mode are performed by a charger according to a second example of the present disclosure.

As shown in FIG. 4, the internal temperature of the charger 10 in a normal state (interval between t0 and t1) may be equal to or less than the reference temperature, and when the internal temperature of the charger 10 is equal to or less than the reference temperature, the controller 300 controls the output of the charger 10 to 100%. Thereafter, as in the interval between t1 and t2, if the internal temperature of the charger 10 exceeds the reference temperature of 60 degrees Celsius, the controller 300 controls the output of the charger 10 to 90%, which is 10% reduced from the 100%. Thereafter, if the internal temperature of the charger 10 is decreased to the reference temperature of 60 degrees Celsius or less at the time point t21 of the interval between t2 and t3, the controller 300 does not increase the output of the charger 10 again at the timepoint t21 or t2 and maintains the output of the charger 10 at 90% until time point t31 at which a predetermined time has elapsed from the time point t21. The controller 300 may only increase the output of the charger 10 to 100% if the internal temperature of the charger 10 is maintained at 60 degrees Celsius or less at the time point t31. This is to check whether the charger 10 is stable. If the internal temperature of the charger 10 is increased to exceed 60 degrees Celsius in the interval between t21 and t31, the controller 300 may control the charger 10 to reduce the output from 90% to 80% at the time point t31.

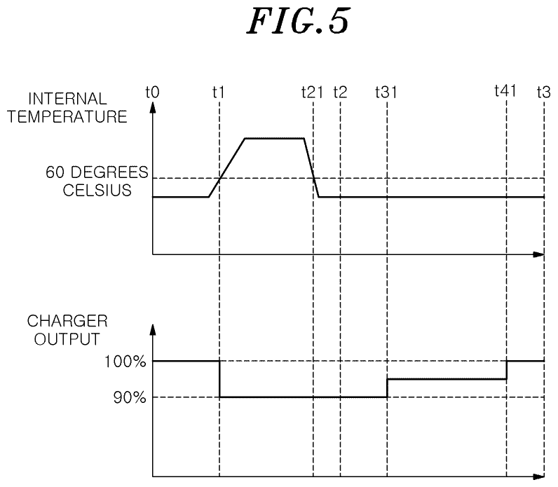

FIG. 5 illustrates an internal temperature of a charger and an output of a charger when the first monitoring mode and the second monitoring mode are performed by a charger according to a third example of the present disclosure.

As shown in FIG. 5, an interval between t0 and t1 and an interval between t1 and t2 are identical to the charger of the first and the second example of the present disclosure, and therefore a detailed description is omitted.

As shown in FIG. 5, if the internal temperature of the charger 10 is equal to or below 60 degrees Celsius at the time point t21, the controller 300 maintains the output of the charger 10 from the time point t21 to t31 at 90%. The controller 300 restores the output to 95% instead of 100% at the time point t31, and restores the output to 100% at a time point t41 at which a predetermined time has elapsed from the time point t31. Thus, the charger according to the third example of the present disclosure restores the magnitude of the charging current in a step-wise manner. This is to respond more stably to sudden changes in the internal temperature of the charger 10 caused by various factors.

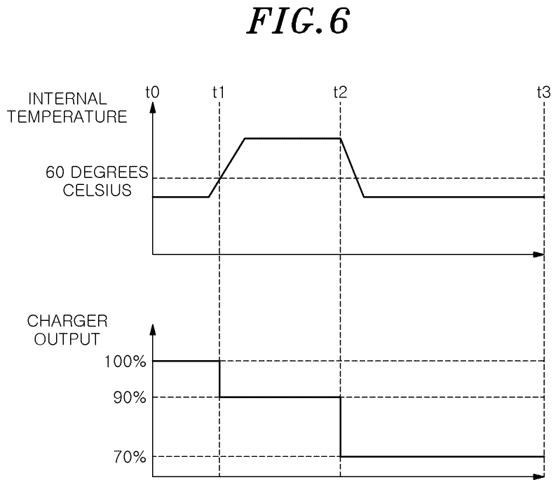

FIG. 6 illustrates an internal temperature and an output of a charger when the first monitoring mode and the second monitoring mode are performed by a charger according to a fourth example of the present disclosure.

As shown in FIG. 6, in the charger according to the fourth example of the present disclosure, when the condition for the second monitoring mode to be performed at the time point t2 is satisfied, the output of the charger 10 is reduced by 20% instead of 10% as in the first monitoring mode. This is to ensure that if the first monitoring mode reduces the output of charger 10 by 10%, but the internal temperature of the charger 10 does not decrease, it is determined as a more serious situation, and the output of the charger 10 is preemptively reduced further to make the charger 10 more stable.

The following is a list of examples of the present disclosure.
Item 1 is a charger for charging an electric vehicle, including a sensing unit configured to sense an internal temperature of the charger; and a controller provided at the charger, configured to control an output of the charger while charging an electric vehicle, and to perform a first monitoring mode in which the output is controlled to be reduced when the internal temperature of the charger sensed at the sensing unit exceeds a reference temperature; wherein the controller is configured to perform a second monitoring mode in which the output is controlled to be further reduced when the internal temperature of the charger exceeds the reference temperature after a predetermined time has elapsed from reducing the output, and wherein the output reduced in the first monitoring mode is identical to or smaller than the output reduced in the second monitoring mode.
Item 2 is the charger of item 1, wherein the controller is configured to repeatedly perform the second monitoring mode.
Item 3 is the charger of items 1 and 2, wherein the output has a predetermined lower limit.
Item 4 is the charger of items 1 to 3, wherein the controller is configured to control to increase the output if the internal temperature of the charger is equal to or less than the reference temperature after the first monitoring mode has been performed.
Item 5 is the charger of items 1 to 4, wherein the controller is configured to control to increase the output if the internal temperature of the charger is equal to or less than the reference temperature after the second monitoring mode has been performed.
Item 6 is the charger of items 1 to 5, wherein the sensing unit includes a temperature sensor with a Schmitt trigger method applied.
Item 7 is the charger of items 1 to 6, wherein the controller is configured to control to increase the output after a preset time has elapsed from the time point at which the internal temperature of the charger is reduced to the reference temperature or below, if the internal temperature of the charger is reduced to the reference temperature or below after performing the first monitoring mode.
Item 8 is the charger of items 1 to 7, wherein the controller is configured to control to increase the output after a preset time has elapsed from the time point at which the internal temperature of the charger is reduced to the reference temperature or below, if the internal temperature of the charger is reduced to the reference temperature or below after performing the second monitoring mode.

While preferred embodiments of the present disclosure have been described above, the embodiments disclosed herein are intended to illustrate and not to limit the technical ideas of the present disclosure. Therefore, the technical idea of the present disclosure includes not only each disclosed embodiment, but also a combination of the disclosed embodiments, and furthermore, the scope of the technical idea of the present disclosure is not limited by these embodiments. Further, those skilled in the art to which the present disclosure belongs may make many changes and modifications to the disclosure without departing from the spirit and scope of the appended claims, and all such appropriate changes and modifications should be considered as equivalents and as falling within the scope of the invention.

What is claimed is:

1. A charger for charging at least one electric vehicle, the charger comprising:
a sensor configured to sense an internal temperature of the charger; and
a controller provided at the charger and configured to control an output of the charger while charging an electric vehicle, and to perform a first monitoring mode, in which the output is controlled to be reduced, based on the internal temperature of the charger sensed at the sensor exceeding a reference temperature,
wherein the controller is configured to perform a second monitoring mode, in which the output is controlled to be further reduced, based on the internal temperature of the charger exceeding the reference temperature after a predetermined time has elapsed from a time associated with a reduction of the output in the first monitoring mode, and
wherein the output reduced in the first monitoring mode is identical to or smaller than the output reduced in the second monitoring mode.

2. The charger of claim 1, wherein the controller is configured to repeatedly perform the second monitoring mode.

3. The charger of claim 2, wherein the output has a predetermined lower limit.

4. The charger of claim 1, wherein the controller is configured to control to increase the output, that is reduced during the first monitoring mode, based on the internal temperature of the charger being equal to or less than the reference temperature after the first monitoring mode has been performed.

5. The controller of claim 4, wherein the controller is configured to control to increase the output, that is reduced during the first monitoring mode, after a preset time has elapsed from a time point at which the internal temperature of the charger is reduced to the reference temperature or below, based on the internal temperature of the charger being reduced to the reference temperature or below after performing the first monitoring mode.

6. The charger of claim 1, wherein the controller is configured to control to increase the output, that is reduced during the second monitoring mode, based on the internal temperature of the charger being equal to or less than the reference temperature after the second monitoring mode has been performed.

7. The charger of claim 6, wherein the controller is configured to control to increase the output, that is reduced during the second monitoring mode, after a preset time has elapsed from a time point at which the internal temperature of the charger is reduced to the reference temperature or below, based on the internal temperature of the charger being reduced to the reference temperature or below after performing the second monitoring mode.

8. The charger of claim 1, wherein the sensor comprises a temperature sensor with which a Schmitt trigger method applied.
